(19) United States
(12) Patent Application Publication
(10) Pub. No.: US 2013/0231812 A1
(43) Pub. Date: Sep. 5, 2013

(54) CONTROLLER FOR HYBRID VEHICLE

(71) Applicant: DENSO CORPORATION, Kariya-City (JP)

(72) Inventors: Daisuke TOKUMOCHI, Kariya-city (JP); Motoyoshi HATTA, Kariya-city (JP)

(73) Assignee: DENSO CORPORATION, Kariya-city (JP)

(21) Appl. No.: 13/783,899

(22) Filed: Mar. 4, 2013

(30) Foreign Application Priority Data
Mar. 5, 2012 (JP) 2012-47709

(51) Int. Cl. B60W 20/00

(52) U.S. Cl. CPC B60W 20/00; Y10S 903/947
USPC 701/22; 180/65.27; 903/947

(57) ABSTRACT

When it is determined that a negative pressure is insufficient, an EGR-close control is executed so that an EGR valve is driven toward a close position to increase the negative pressure in an intake passage. After that, it is determined whether the negative pressure detected by a pressure sensor is restored to a specified target negative pressure. When the negative pressure is not restored to the target negative pressure even when a specified time period has elapsed after it is determined that the negative pressure is insufficient, an automatic brake unit executes a braking-force assist control to assist a braking force of a brake. A shortage of the braking force due to an insufficient negative pressure is compensated by the braking force generated by the automatic brake unit.

### CROSS-REFERENCE TO RELATED APPLICATION

This application is based on Japanese Patent Application No. 2012-47709 filed on Mar. 5, 2012, the disclosure of which is incorporated herein by reference.

### TECHNICAL FIELD

The present disclosure relates to a controller for a hybrid vehicle equipped with a brake booster of negative-pressure type.

### BACKGROUND

A hybrid vehicle is equipped with an internal combustion engine and a motor-generator (MG). The MG is provided in a power-transmitting system between the engine and a transmission.

When a hybrid vehicle is decelerated, a regenerative deceleration (regenerative brake) is conducted. In such a regenerative deceleration, a motive power of wheels drives the MG so that kinetic energy of the vehicle is converted into electric power to be charged in a battery. At this moment, if the engine is rotated along with the MG, an energy recovery amount by the regenerative deceleration may be decreased due to an energy loss, a pumping loss and a friction loss.

JP-08-100689A shows a regenerating device for an internal combustion engine. The engine is provided with an EGR apparatus for recirculating a part of exhaust gas to an intake passage. When a vehicle is decelerated, an EGR valve is fully opened to decrease negative pressure in the intake passage, whereby a pumping loss of the engine is reduced. Some kinds of vehicles are provided with a brake booster of negative-pressure type.

The brake booster introduces the negative pressure in the intake pipe to the brake booster, and increases a stepping-in force of a brake pedal by utilizing a differential pressure between the negative pressure and the atmospheric pressure, whereby the braking force is increased.

JP-10-73039A shows an engine control system in which an EGR valve is closed to reduce the EGR gas quantity when the negative pressure runs shortage, whereby the negative pressure is ensured.

However, in the engine control system shown in JP-10-73039A, it is likely that a time period required for the negative pressure to be restored to a target negative pressure may disperse according to the engine speed. The negative pressure may become unstable. For example, when the negative pressure in the brake booster is rapidly decreased due to a pumping braking at the time of deceleration, it is likely that the desired deceleration may not be achieved.

### SUMMARY

It is an object of the present disclosure to provide a controller for a hybrid vehicle equipped with a brake booster of negative-pressure type, which is able to ensure a desired deceleration even if a negative pressure runs shortage at a time of deceleration of a vehicle.

According to the present disclosure, a hybrid vehicle which is equipped with an engine; a motor generator disposed in a power transmitting system between the engine and a wheel; a negative-pressure type brake booster amplifying a stepping-in force of a brake pedal in order to increase a braking force of a brake by using of a negative pressure in an intake passage of the engine; an EGR valve adjusting a quantity of an exhaust gas recirculating into the intake passage; and an automatic brake unit electronically controlling the braking force of the brake.

A controller for the hybrid vehicle includes: a negative-pressure-determination portion for determining whether the negative pressure is insufficient based on the negative pressure and a decrease amount of the negative pressure at a time of a deceleration of the hybrid vehicle; an EGR-close control portion for performing an EGR-close control in which the EGR valve is driven to a close position when the negative-pressure-determination portion determines that the negative pressure is insufficient; and an automatic brake unit for performing a braking-force assist control to compensate the braking force of the brake when the negative pressure is not restored to a target negative pressure in a specified time after the negative-pressure-determination portion determines that the negative pressure is insufficient.

According to the above configuration, when it is determined that the negative pressure is insufficient at a time of deceleration of the vehicle and when the negative pressure is not restored to the target negative pressure in the specified time even though the EGR-close control is executed, the automatic brake unit performs the braking-force assist control to compensate the braking force of the brake. Thereby, the shortage of the braking force due to the insufficient negative pressure is compensated by the braking force generated by the automatic brake unit. Even if the negative pressure becomes insufficient at the time of deceleration of the vehicle, the desired deceleration can be ensured.

According to another aspect of the present disclosure, a hybrid vehicle is equipped with an engine; a motor generator and a transmission disposed in a power transmitting system between the engine and a wheel. The hybrid vehicle is further equipped a negative-pressure type brake booster amplifying a stepping-in force of a brake pedal in order to increase a braking force of a brake by using of a negative pressure in an intake passage of the engine; and an EGR valve adjusting a quantity of an exhaust gas recirculating into the intake passage.

A controller for the hybrid vehicle includes: a negative-pressure-determination portion for determining whether the negative pressure is insufficient based on the negative pressure and a decrease amount of the negative pressure at a time of a deceleration of the hybrid vehicle; an EGR-close control portion for performing an EGR-close control in which the EGR valve is driven to a close position when the negative-pressure-determination portion determines that the negative pressure is insufficient; and an engine-speed-increase portion for performing an engine-speed increase control in which an engine speed of the engine is increased by using of at least one of the motor-generator and the transmission when the negative-pressure-determination portion determines that the negative pressure is insufficient.

According to the above configuration, when it is determined that the negative pressure is insufficient at a time of deceleration of the vehicle the EGR-close control and the engine-speed increase control are performed. Thereby, the negative pressure is promptly restored to the target negative pressure, so that the braking force of the brake never becomes insufficient. Even if the negative pressure becomes insufficient at a time of deceleration of the vehicle, the deceleration required by a driver is certainly ensured.

Furthermore, the controller may includes an automatic brake unit electronically controlling the braking force of the brake; and an automatic brake unit for performing a braking-force assist control to compensate the braking force of the brake when the negative pressure is not restored to a target negative pressure in a specified time after the negative-pressure-determination portion determines that the negative pressure is insufficient. When it is determined that the negative pressure is insufficient at the time of deceleration of the vehicle and when the negative pressure is not restored to the target negative pressure in the specified time even though the EGR-close control and the engine-speed increase control are executed, the automatic brake unit performs the braking-force assist control to compensate the braking force of the brake. Thereby, the shortage of the braking force due to the insufficient negative pressure is compensated by the braking force generated by the automatic brake unit 34. The deceleration required by a driver is certainly ensured.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of a power transmitting system of a hybrid vehicle according to a first embodiment;

FIG. 2 is a schematic view of a control system of the hybrid vehicle according to the first embodiment;

FIG. 3 is a chart for explaining an operation characteristic of a brake;

FIG. 4 is a chart showing a relationship between a brake pedal stepping-in force and a brake drive oil pressure.

FIG. 5 is a time chart for explaining a deceleration-control according to the first embodiment;

FIG. 6 is a flow chart showing a processing of a deceleration-control routine according to the first embodiment;

FIG. 7 is a chart conceptually showing a negative-pressure-determination map;

FIG. 8 is a time chart for explaining a deceleration-control according to a second embodiment;

FIG. 9 is a flow chart showing a processing of a deceleration-control routine according to the second embodiment;

FIG. 10 is a chart conceptually showing a map of an injection cycle of the reforming-fuel;

FIG. 11 is a time chart for explaining a deceleration-control according to a third embodiment;

FIG. 12 is a flow chart showing a processing of a deceleration-control routine according to the third embodiment; and

FIG. 13 is a schematic view of a power transmitting system of a hybrid vehicle according to another embodiment.

### DETAILED DESCRIPTION

Embodiments of the present invention will be described, hereinafter.

### First Embodiment

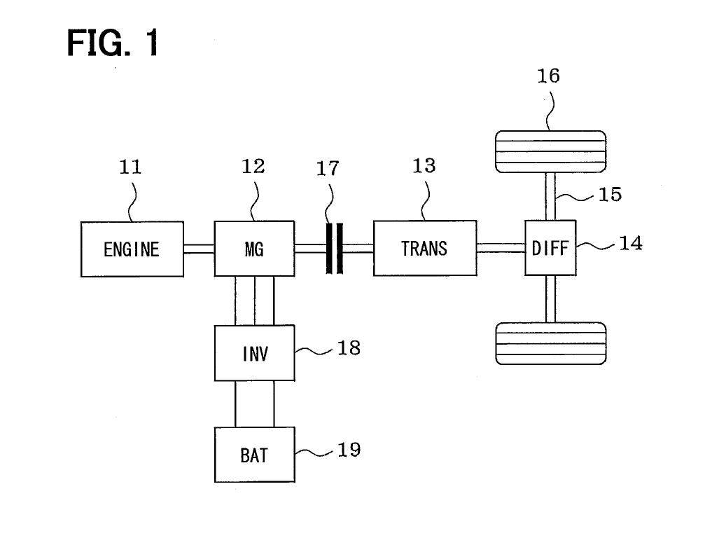

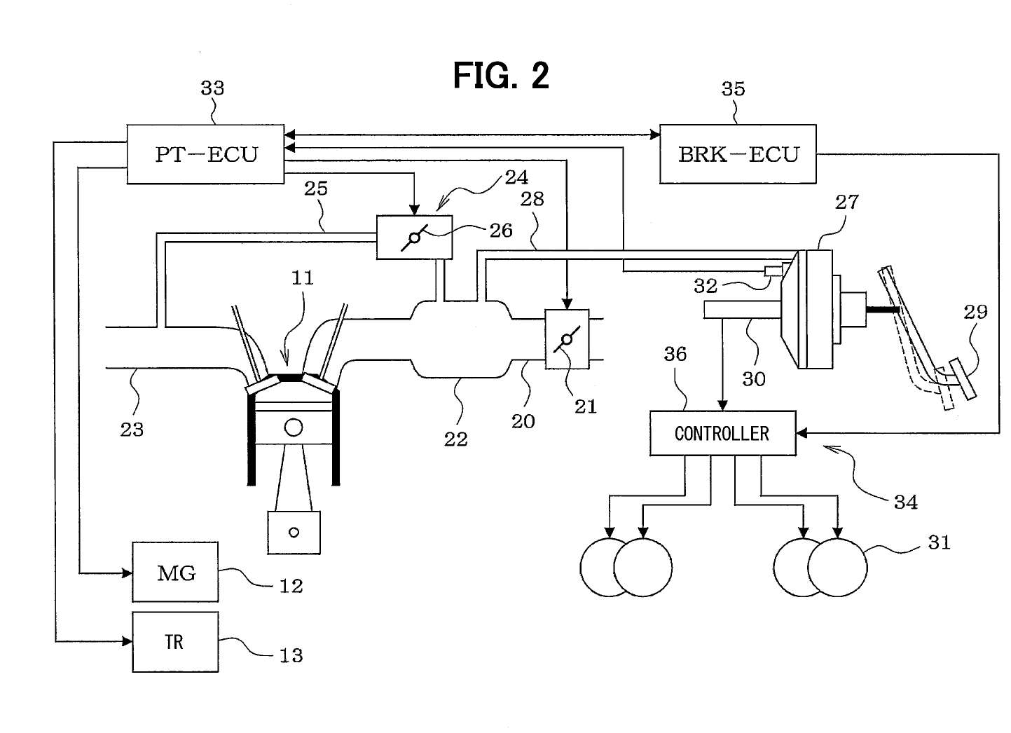

Referring to FIGS. 1 to 7, a first embodiment will be described hereinafter. Based on FIGS. 1 and 2, a power transmitting system and a control system of a hybrid vehicle will be explained.

The hybrid vehicle is equipped with an internal combustion engine 11 and a motor-generator (MG) 12. A power of an output shaft (crankshaft) of the engine 11 is transferred to the transmission 13 through the MG 12. The power of the output shaft of the transmission 13 is transferred to wheels 16 through a differential gear mechanism 14 and axles 15. The transmission 13 may be a continuously variable transmission (CVT). The MG 12 is disposed between the engine 11 and the transmission 13. A clutch 17 is disposed between the MG 12 and the transmission 13. This clutch 17 may be a hydraulic clutch or an electromagnetic clutch. An inverter 18 driving the MG 18 is connected to a battery 19, so that electric power is delivered between the MG 12 and the battery 19 through the inverter 18.

As shown in FIG. 2, a throttle valve 21 driven by a motor is disposed in an intake pipe (intake passage) 20. A surge tank 22 is provided downstream of the throttle valve 21. The engine 11 is provided with an exhaust gas recirculation (EGR) apparatus 24 for recirculating a part of exhaust gas from an exhaust pipe 20 into the intake pipe 20. The EGR apparatus 24 has an EGR pipe 25 connecting the exhaust pipe 23 and the intake pipe 20. An EGR valve 26 adjusting the EGR gas quantity is provided in the EGR pipe 25.

A negative-pressure-introduction pipe 28 is connected to the surge tank 22 so that the negative pressure in the intake pipe 20 is introduced into the brake booster 27. The brake booster 27 amplifies the stepping-in force of a brake pedal 29 by utilizing a differential pressure between the negative pressure and the atmospheric pressure. The amplified stepping-in force is transferred to a piston (not shown) of a master cylinder 30. The hydraulic pressure in the master cylinder 30 is increased to increase the driving hydraulic pressure of the brake 31 provided to each wheel, whereby the braking force of each brake 31 is increased. A pressure sensor 32 which detects the negative pressure introduced into the brake booster 27 is provided to the brake booster 27.

A PT-ECU 33 is a computer which controls the power transmitting system of the hybrid vehicle. Specifically, the PT-ECU 33 controls the engine 11, the MG 12 and the transmission 13 according to a driving condition of the vehicle. When a hybrid vehicle is decelerated, a regenerative deceleration (regenerative brake) is conducted. In such a regenerative deceleration, a motive power of wheels 16 drives the MG 12 so that kinetic energy of the vehicle is converted into electric power to be charged in a battery 19.

Furthermore, the PT-ECU 33 controls an automatic brake unit 34 according to the driving condition of the vehicle. The automatic brake unit 34 is comprised of a BRK-ECU 35 which controls a hydraulic controller 36 (a hydraulic pump, a pressure regulating valve, etc.) so that the driving hydraulic pressure of the brake 31 is controlled.

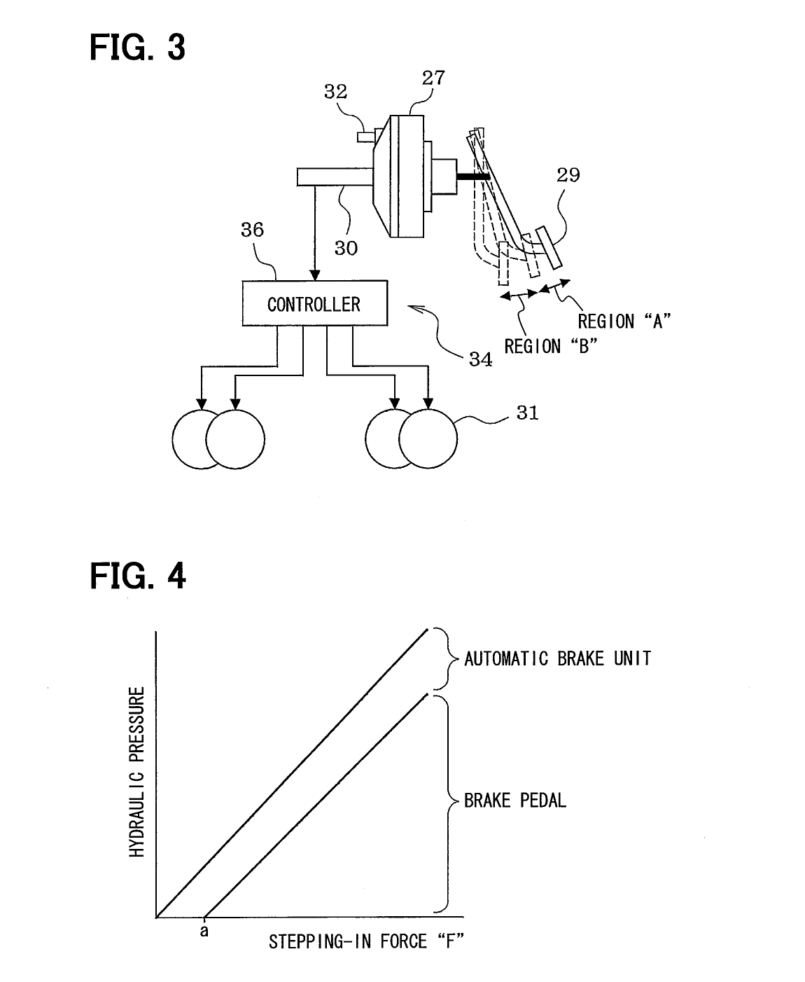

As shown in FIGS. 3 and 4, in a region “A” where the stepping-in force “F” of the brake pedal 29 is not greater than a specified value “a”, the hydraulic pressure by operating the brake pedal 29 is hardly generated. The hydraulic pressure in the master cylinder 30 hardly rises. The PT-ECU 33 controls the torque of the MG 12 so that the braking force is generated according to the stepping-in force “F” in cooperation with the regenerative brake by the MG 12 and the automatic brake unit 34. Further, the hydraulic controller 36 controls the driving hydraulic pressure of the brake 31.

Meanwhile, in a region “B” where the stepping-in force “F” of the brake pedal 29 is greater than the specified value “a”, the hydraulic pressure in the master cylinder 30 rises according to the stepping-in force “F”. The driving hydraulic pressure of the brake 31 is increased so that the braking force of the brake 31 increases. Moreover, the hydraulic controller 36 controls the driving hydraulic pressure of the brake 31.

For example, when the negative pressure in the brake booster 27 is rapidly decreased due to a pumping braking at the time of deceleration, it is likely that the desired deceleration may not be achieved.

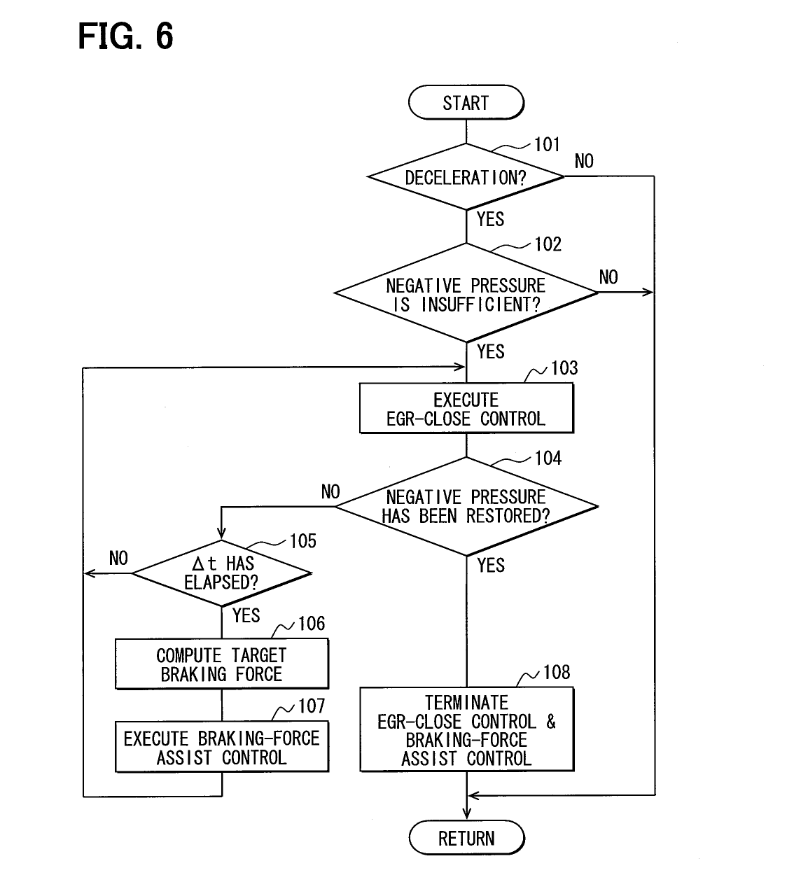

According to the first embodiment, the PT-ECU 33 executes a deceleration-control routine shown in FIG. 6 when the vehicle is decelerated.

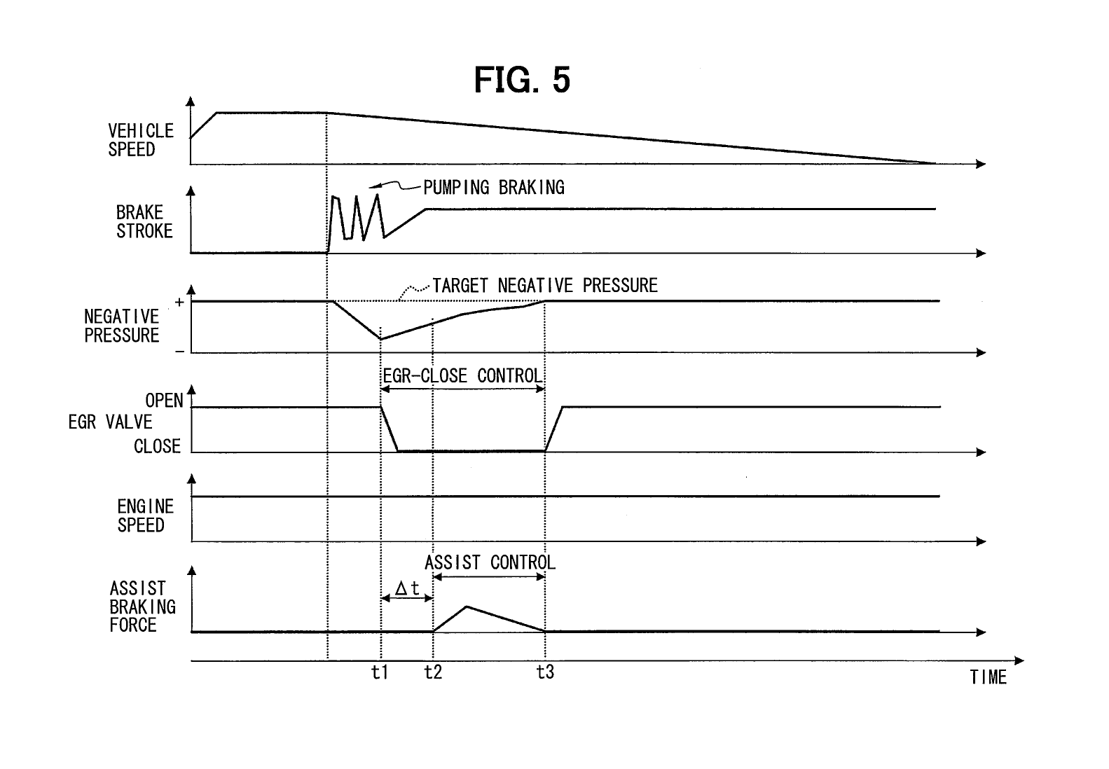

As shown in a time chart of FIG. 5, when the vehicle is decelerated, the computer determines whether the negative pressure is insufficient based on the negative pressure detected by the pressure sensor 32 and a decrease amount of the negative pressure.

For example, when the negative pressure in the brake booster 27 is rapidly decreased due to a pumping braking and the computer determines that the negative pressure is insufficient at a time t1, an EGR-close control is executed so that the EGR valve 26 is driven toward a close position. In the EGR-close control, the opening degree of the EGR valve 26 is adjusted to a target opening degree which is predetermined or established according to the negative pressure. Alternatively, the EGR valve 26 may be fully closed. Thereby, the EGR gas quantity is reduced or made zero, so that the negative pressure in the intake pipe 20 is increased. That is, the pressure in the intake pipe 20 is decreased toward vacuum.

After that, the computer determines whether the negative pressure detected by the pressure sensor 32 is restored to a specified target negative pressure. When the negative pressure is not restored to the target negative pressure even after a specified time period At has elapsed after the time t1, the automatic brake unit 34 executes a braking-force assist control to assist the braking force of the brake 31 at a time t2. In the braking-force assist control, the braking force of the brake 31 generated by the automatic brake unit 34 is increased by a specified amount which corresponds to the decrease in braking force due to a shortage of negative pressure. Thereby, the shortage of the braking force due to the insufficient negative pressure is compensated by the braking force generated by the automatic brake unit 34.

Then, when the computer determines that the negative pressure detected with the pressure sensor 32 is restored to the target negative pressure, the EGR-close control and the braking-force assist control are terminated at a time t3.

The above described deceleration-control is executed by the PT-ECU 33 according to the deceleration-control routine shown in FIG. 6. The process of this routine will be described hereinafter.

The deceleration-control routine is executed at specified intervals while the PT-ECU 33 is ON. In step 101, the computer determines whether the vehicle is decelerated. When the answer is NO, the procedure ends.

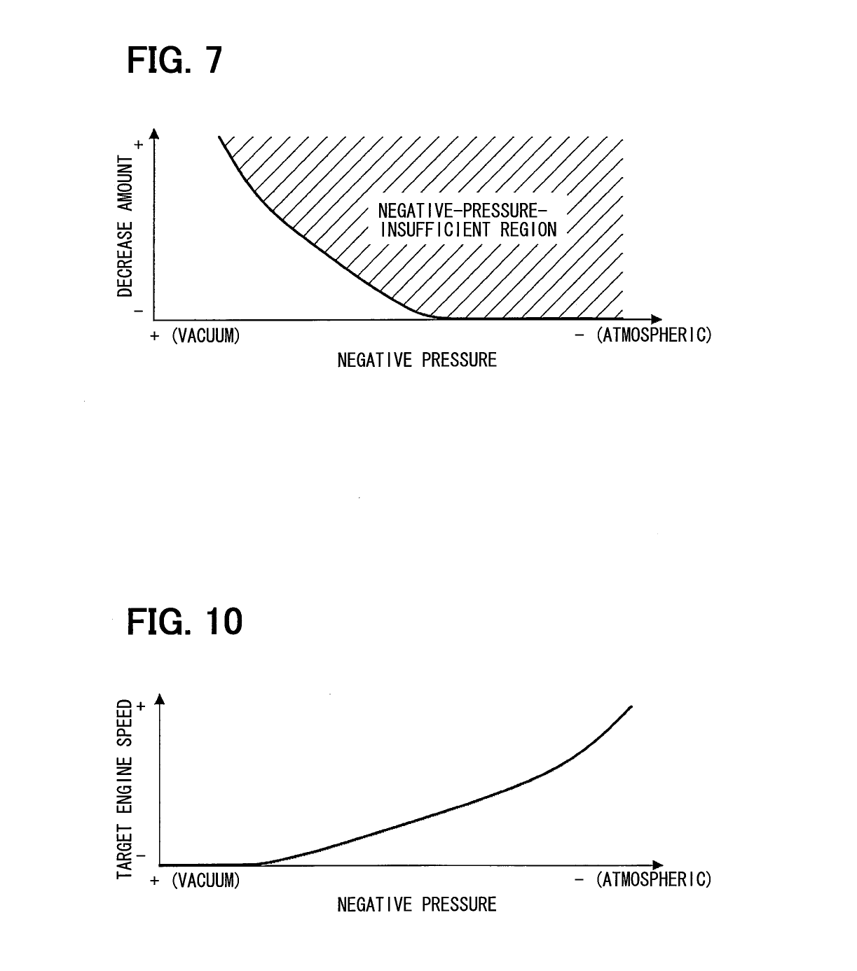

When the answer is YES in step 101, the procedure proceeds to step 102 in which the computer determines whether the negative pressure is insufficient based on the negative pressure detected by the pressure sensor 32 and a decrease amount of the negative pressure. Specifically, in view of a negative-pressure-determination map shown in FIG. 7, the computer determines whether the negative pressure is insufficient based on whether the negative pressure and the decrease amount are in a negative-pressure-insufficient region. The negative-pressure-determination map is previously formed based on experimental data and design data, and is stored in the ROM of the PT-ECU 33. The process in step 102 corresponds to a negative-pressure-determination portion.

When the answer is NO in step 102, the routine is finished without performing the subsequent steps.

When the answer is YES in step 102, the procedure proceeds to step 103 in which the EGR-close control is executed. In the EGR-close control, the opening degree of the EGR valve 26 is adjusted to a target opening degree which is predetermined or established according to the negative pressure. Alternatively, the EGR valve 26 may be fully closed. Thereby, the EGR gas quantity is reduced or made zero, so that the negative pressure in the intake pipe 20 is increased. That is, the pressure in the intake pipe 20 is decreased toward vacuum. The process in step 103 corresponds to an EGR-close control portion.

Then, the procedure proceeds to step 104 in which the computer determines whether the negative pressure detected by the pressure sensor 32 has been restored to the specified target negative pressure. The target negative pressure is set as negative pressure required for the brake booster 27 to normally operate.

When the answer is NO in step 104, the procedure proceeds to step 105 in which the computer determines whether a specified time At has elapsed after it was determined the negative pressure is insufficient. When the answer is NO in step 105, the procedure goes back to step 103.

When the answer is NO in step 104 and the answer is YES in step 105, the procedure proceeds to step 106. In step 106, the computer computes a target braking force of the automatic brake unit 34. Specifically, the computer computes the target braking force based on the negative pressure detected by the pressure sensor 32 and the target negative pressure so that the braking force of the brake 31 is increased by the amount corresponding to the shortage of barking force of the brake 31 due to the shortage of negative pressure.

Then, the procedure proceeds to step 107 in which the automatic brake unit 34 executes the braking-force assist control to assist the braking force of the brake 31. In the braking-force assist control, the hydraulic controller 36 controls the driving hydraulic pressure of the brake 31 so that the braking force of the brake 31 becomes the target braking force. The braking force of the brake 31 generated by the automatic brake unit 34 is increased by a specified amount which corresponds to the decrease in braking force due to a shortage of negative pressure. Thereby, the shortage of the braking force due to the insufficient negative pressure is compensated by the braking force generated by the automatic brake unit 34. The process in step 107 corresponds to a braking force correction portion.

Then, when the computer determines that the negative pressure detected with the pressure sensor 32 is restored to the target negative pressure in step 104, the procedure proceeds to step 108 in which the EGR-close control and the braking-force assist control are terminated.

According to the above first embodiment, when it is determined that the negative pressure is insufficient at the time of deceleration of the vehicle and when the negative pressure is not restored to the target negative pressure in the specified time Δt even though the EGR-close control is executed, the automatic brake unit 34 performs the braking-force assist control to compensate the braking force of the brake 31. Thereby, the shortage of the braking force due to the insufficient negative pressure is compensated by the braking force generated by the automatic brake unit 34. Even if the negative pressure becomes insufficient at the time of deceleration of the vehicle, the desired deceleration can be ensured.

### Second Embodiment

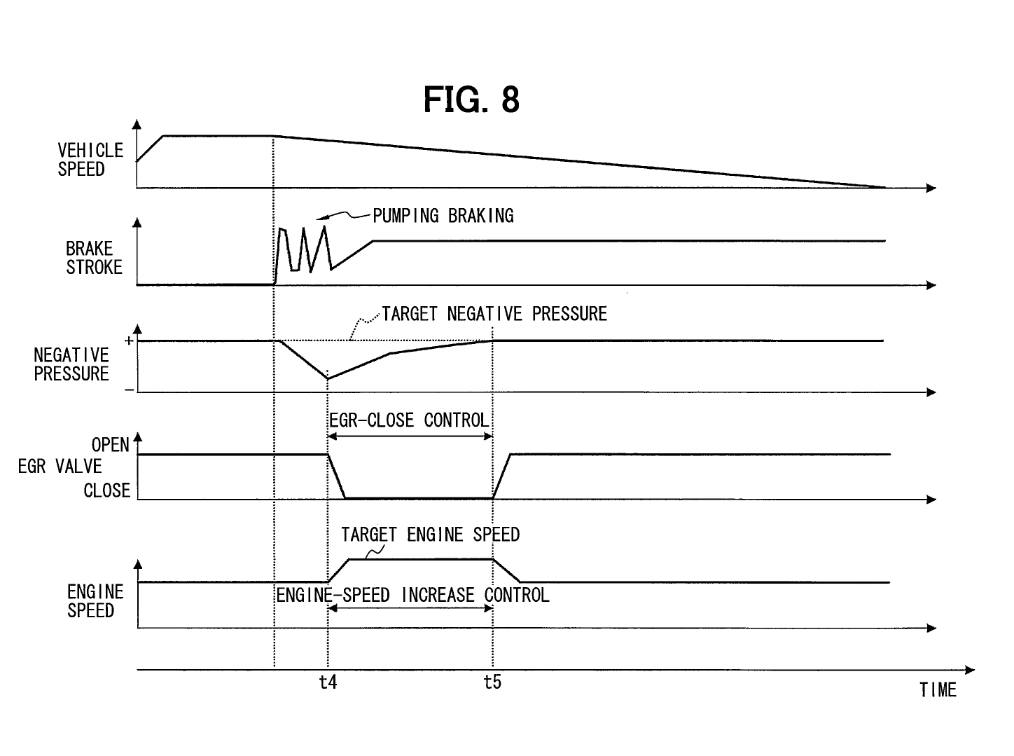

Referring to FIGS. 8 to 10, a second embodiment will be described hereinafter. In the second embodiment, the same parts and components as those in the first embodiment are indicated with the same reference numerals and the same descriptions will not be reiterated.

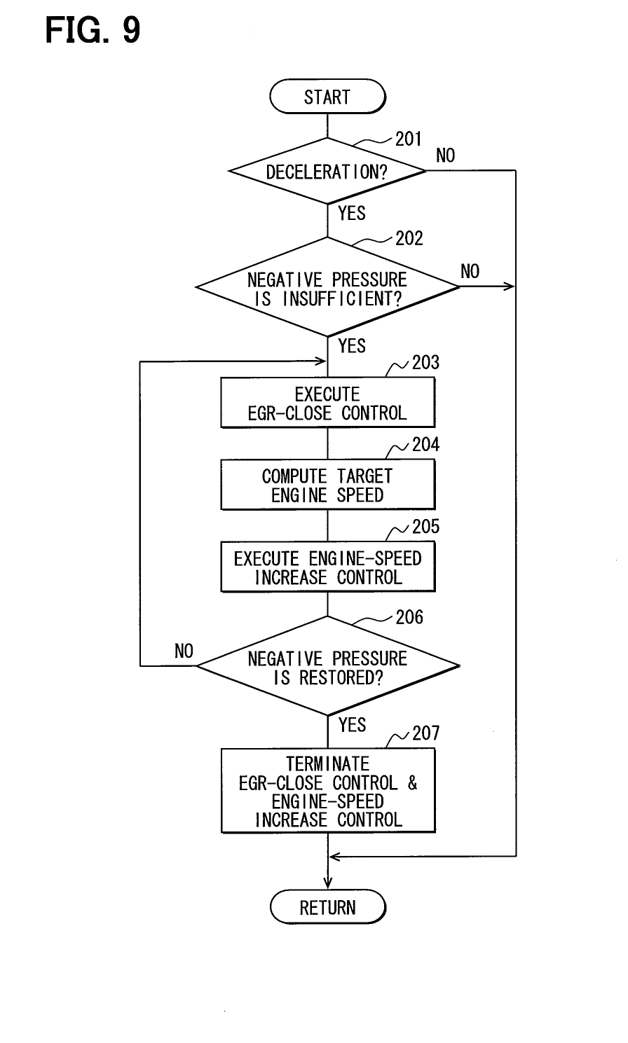

According to the second, the PT-ECU 33 executes a deceleration-control routine shown in FIG. 9 when the vehicle is decelerated.

As shown in a time chart of FIG. 9, when the vehicle is decelerated, it is determined whether the negative pressure is insufficient based on the negative pressure detected by the pressure sensor 32 and its decrease amount. When it is determined that the negative pressure is insufficient at a time t4, the EGR-close control is executed and an engine-speed increase control is executed to increase the engine speed. In the engine-speed increase control, a change gear ratio (reduction ratio) of the transmission 13 is increased to increase the engine speed. Alternatively, the MG 12 drives the engine 11 to increase the engine speed. These operations may be conducted at the same time. Thereby, the negative pressure is promptly restored to the target negative pressure, so that the braking force of the brake 31 never becomes insufficient.

Then, the computer determines whether the negative pressure detected by the pressure sensor 32 is restored to the target negative pressure. When the negative pressure is restored to the target negative pressure, the EGR-close control and the engine-speed increase control are terminated at a time t5.

The above described deceleration-control is executed by the PT-ECU 33 according to the deceleration-control routine shown in FIG. 9.

In step 201, the computer determines whether the vehicle is decelerating. When the answer is YES, the procedure proceeds to step 202 in which the computer determines whether the negative pressure is insufficient. Specifically, in view of the negative-pressure-determination map shown in FIG. 7, the computer determines whether the negative pressure is insufficient based on whether the negative pressure and the decrease amount are in a negative-pressure-insufficient region.

When the answer is YES in step 202, the procedure proceeds to step 203 in which the EGR-close control is executed.

Then, the procedure proceeds to step 204 in which the computer computes a target engine speed which is required to promptly restore the negative pressure to the target negative pressure. Specifically, in view of a target-engine-speed map shown in FIG. 10, a target engine speed is computed according to the negative pressure. The target-engine-speed map is previously formed based on experimental data and design data, and is stored in the ROM of the PT-ECU 33.

Then, the procedure proceeds to step 205 in which the engine-speed increase control is performed. In the engine-speed increase control, a change gear ratio (reduction ratio) of the transmission 13 is increased to increase the engine speed. Alternatively, the

MG 12 drives the engine 11 to increase the engine speed. These operations may be conducted at the same time. Thereby, the negative pressure is promptly restored to the target negative pressure, so that the braking force of the brake 31 never becomes insufficient. The process in step 205 corresponds to an engine-speed-increase portion.

Then, the procedure proceeds to step 206 in which the computer determines whether the negative pressure detected by the pressure sensor 32 is restored to the target negative pressure. When the negative pressure is not restored to the target negative pressure, the procedure goes back to step 203.

When the computer determines that the negative pressure is restored to the target negative pressure in step 206, the procedure proceeds to step 207 in which the EGR-close control and the engine-speed increase control are terminated.

According to the above second embodiment, when it is determined that the negative pressure is insufficient at the time of deceleration of the vehicle, the EGR-close control and the engine-speed increase control are performed. Thereby, the negative pressure is promptly restored to the target negative pressure, so that the braking force of the brake 31 never becomes insufficient. Even if the negative pressure becomes insufficient at the time of deceleration of the vehicle, the desired deceleration can be ensured.

### Third Embodiment

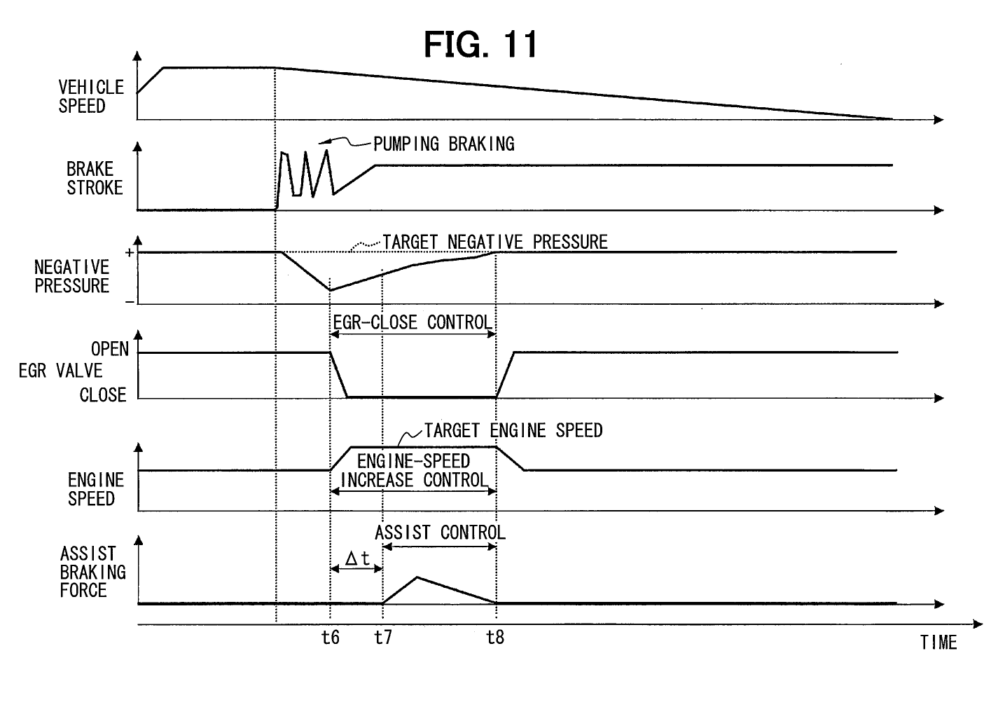

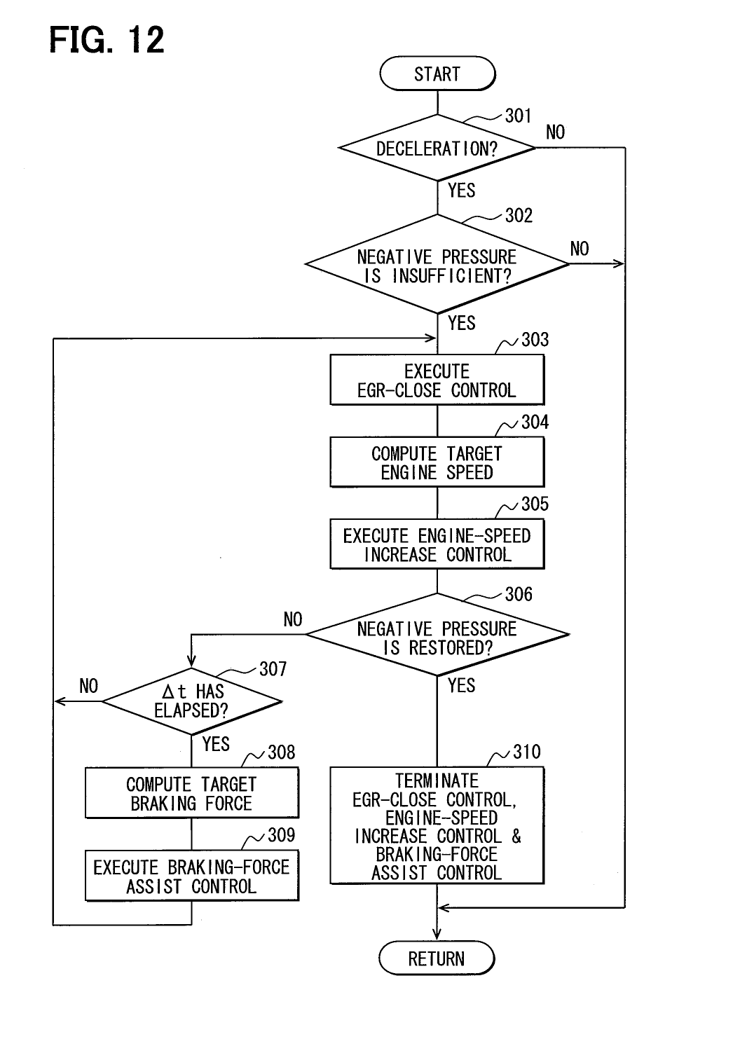

Referring to FIGS. 11 and 12, a third embodiment will be described hereinafter. In the third embodiment, the same parts and components as those in the first and the second embodiment are indicated with the same reference numerals and the same descriptions will not be reiterated.

According to the third embodiment, the PT-ECU 33 executes a deceleration-control routine shown in FIG. 12 when the vehicle is decelerated.

As shown in a time chart of FIG. 11, when the vehicle is decelerated, it is determined whether the negative pressure is insufficient based on the negative pressure detected by the pressure sensor 32 and its decrease amount. When it is determined that the negative pressure is insufficient at a time t6, the EGR-close control is executed and the engine-speed increase control is executed to increase the engine speed.

After that, the computer determines whether the negative pressure detected by the pressure sensor 32 is restored to the target negative pressure. When the negative pressure is not restored to the target negative pressure even after a specified time period At has elapsed after the time t6, the automatic brake unit 34 executes a braking-force assist control to assist the braking force of the brake 31 at a time t7.

Then, when the computer determines that the negative pressure detected with the pressure sensor 32 is restored to the target negative pressure, the EGR-close control, the engine-speed increase control and the braking-force assist control are terminated at a time t8.

The above described deceleration-control is executed by the PT-ECU 33 according to the deceleration-control routine shown in FIG. 12.

In step 301, the computer determines whether the vehicle is decelerating. When the answer is YES, the procedure proceeds to step 302 in which the computer determines whether the negative pressure is insufficient. Specifically, in view of the negative-pressure-determination map shown in FIG. 7, the computer determines whether the negative pressure is insufficient based on whether the negative pressure and the decrease amount are in a negative-pressure-insufficient region.

When the answer is YES in step 302, the procedure proceeds to step 303 in which the EGR-close control is executed.

Then, the procedure proceeds to step 304 in which the computer computes a target engine speed which is required to promptly restore the negative pressure to the target negative pressure. Then, the procedure proceeds to step 305 in which the engine-speed increase control is performed.

Then, the procedure proceeds to step 306 in which the computer determines whether the negative pressure detected by the pressure sensor 32 has been restored to the specified target negative pressure. When the answer is NO in step 306, the procedure proceeds to step 307 in which the computer determines whether a specified time At has been elapsed after it was determined the negative pressure is insufficient. When the answer is NO in step 307, the procedure goes back to step 303.

When the answer is NO in step 306 and the answer is YES in step 307, the procedure proceeds to step 308. In step 308, the computer computes a target braking force of the automatic brake unit 34. Then, the procedure proceeds to step 309 in which the automatic brake unit 34 executes the braking-force assist control to assist the braking force of the brake 31.

Then, when the computer determines that the negative pressure detected with the pressure sensor 32 is restored to the target negative pressure in step 306, the procedure proceeds to step 310 in which the EGR-close control, the engine-speed increase control and the braking-force assist control are terminated.

According to the above first embodiment, when it is determined that the negative pressure is insufficient at the time of deceleration of the vehicle and when the negative pressure is not restored to the target negative pressure in the specified time At even though the EGR-close control and the engine-speed increase control are executed, the automatic brake unit 34 performs the braking-force assist control to compensate the braking force of the brake 31. Thereby, the shortage of the braking force due to the insufficient negative pressure is compensated by the braking force generated by the automatic brake unit 34. The deceleration required by a driver is certainly ensured.

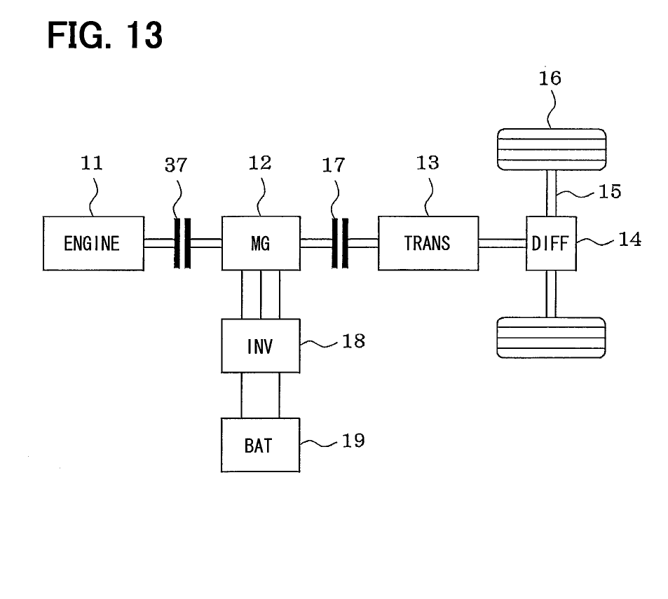

The present disclosure can be applied to a hybrid vehicle which is provided with a first clutch 17 between the MG 12 and the transmission 13 and a second clutch 37 between the engine 11 and the MG 12, as shown in FIG. 13.

What is claimed is:

1. A controller for a hybrid vehicle which is equipped with an engine; a motor generator disposed in a power transmitting system between the engine and a wheel; a negative-pressure type brake booster amplifying a stepping-in force of a brake pedal in order to increase a braking force of a brake by using of a negative pressure in an intake passage of the engine; an EGR valve adjusting a quantity of an exhaust gas recirculating into the intake passage; and an automatic brake unit electronically controlling the braking force of the brake,
the controller comprising:
a negative-pressure-determination portion for determining whether the negative pressure is insufficient based on the negative pressure and a decrease amount of the negative pressure at a time of a deceleration of the hybrid vehicle;
an EGR-close control portion for performing an EGR-close control in which the EGR valve is driven to a close position when the negative-pressure-determination portion determines that the negative pressure is insufficient; and
an automatic brake unit for performing a braking-force assist control to compensate the braking force of the brake when the negative pressure is not restored to a target negative pressure in a specified time after the negative-pressure-determination portion determines that the negative pressure is insufficient.

2. A controller for a hybrid vehicle which is equipped with an engine; a motor generator and a transmission disposed in a power transmitting system between the engine and a wheel; a negative-pressure type brake booster amplifying a stepping-in force of a brake pedal in order to increase a braking force of a brake by using of a negative pressure in an intake passage of the engine; and an EGR valve adjusting a quantity of an exhaust gas recirculating into the intake passage,
the controller comprising:
a negative-pressure-determination portion for determining whether the negative pressure is insufficient based on the negative pressure and a decrease amount of the negative pressure at a time of a deceleration of the hybrid vehicle;
an EGR-close control portion for performing an EGR-close control in which the EGR valve is driven to a close position when the negative-pressure-determination portion determines that the negative pressure is insufficient; and
an engine-speed-increase portion for performing an engine-speed increase control in which an engine speed of the engine is increased by using of at least one of the motor-generator and the transmission when the negative-pressure-determination portion determines that the negative pressure is insufficient.

3. A controller for a hybrid vehicle according to claim 2, further comprising:
an automatic brake unit electronically controlling the braking force of the brake; and
an automatic brake unit for performing a braking-force assist control to compensate the braking force of the brake when the negative pressure is not restored to a target negative pressure in a specified time after the negative-pressure-determination portion determines that the negative pressure is insufficient.
